(19) United States
(12) Patent Application Publication
(10) Pub. No.: US 2013/0325958 A1
(43) Pub. Date: Dec. 5, 2013

(54) INFORMATION-PROCESSING DEVICE, STORAGE MEDIUM, INFORMATION-PROCESSING METHOD, AND INFORMATION-PROCESSING SYSTEM

(71) Applicant: NINTENDO CO., LTD., Kyoto (JP)

(72) Inventors: Kiyoshi MIZUKI, Kyoto (JP); Kouichi KAWAMOTO, Kyoto (JP); Hideto YUZAWA, Kyoto (JP); Shunsaku KATO, Kyoto (JP); Yasumasa NAKAI, Kyoto (JP)

(73) Assignee: NINTENDO CO., LTD., Kyoto (JP)

(21) Appl. No.: 13/771,824

(22) Filed: Feb. 20, 2013

(30) Foreign Application Priority Data
Jun. 1, 2012 (JP) 2012-125825

(51) Int. Cl. H04L 12/58

(52) U.S. Cl. CPC H04L 51/32
USPC 709/204

(57) ABSTRACT

An exemplary information-processing device includes: a first receiving unit that receives handwritten data input via an input device as posted information, the handwritten data showing an handwritten image; and a posting unit that posts the posted information received by the first receiving unit to a service that is provided to one or more communities.

### CROSS REFERENCE TO RELATED APPLICATIONS

This application is based on and claims priorities under 35 USC 119 from Japanese patent application No. 2012-125825, which was filed on Jun. 1, 2012.

### FIELD

The technology herein relates to use of a web service(s) (hereinafter referred to as “service”) for sharing posted information on a network.

### BACKGROUND AND SUMMARY

An information-processing device including a communication function for communicating with another device is known.

The present disclosure provides a technology for posting handwritten message using a service that is provided to an online community (hereinafter referred to as a “community”) for sharing information posted on the Internet.

There is provided an information-processing device including: a first receiving unit that receives handwritten data input via an input device as posted information; and a posting unit that posts the posted information received by the first receiving unit to a service that is provided to one or more communities for sharing of posted information on the Internet.

### BRIEF DESCRIPTION OF THE DRAWINGS

Exemplary embodiments will be described with reference to the following drawings, wherein:

FIG. 1 shows an example of a functional configuration of information-processing system 1 according to an exemplary embodiment;

FIG. 2 shows an example of a hardware configuration of information-processing device 10;

FIG. 3 shows an example of a software configuration of information-processing device 10;

FIG. 4 shows an example of a sequence chart illustrating a process for posting comments;

FIG. 5 shows an example of an image of an input screen for input of handwritten messages;

FIG. 6 shows an example of an image of an input screen of a software keyboard;

FIG. 7 shows an example of data stored in posted information database 212;

FIG. 8 shows an example of a sequence chart illustrating a process for browsing posted information of a community; and

FIG. 9 shows an example of an image of a screen, displaying information on an online community.

### DETAILED DESCRIPTION OF NON-LIMITING EXEMPLARY EMBODIMENTS

### 1. Configuration

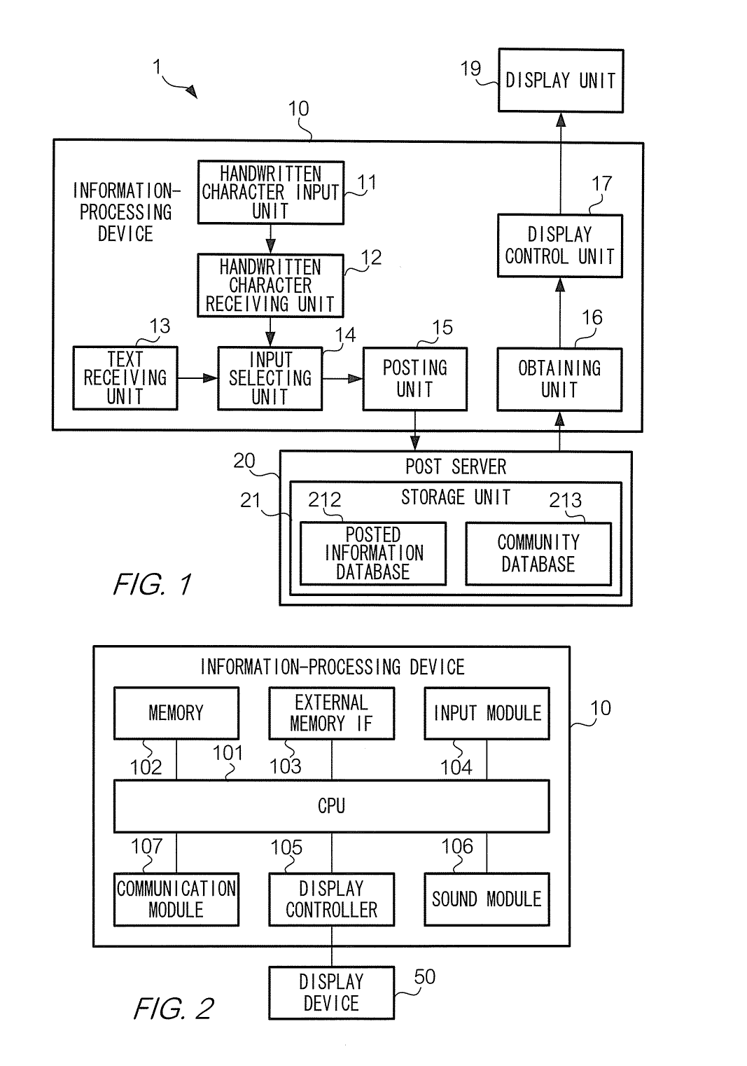

FIG. 1 shows an example of a functional configuration of information-processing system 1 according to an exemplary embodiment. Information-processing system 1 includes a plurality of information-processing devices 10, and post server 20. In the example of information-processing system 1 shown in FIG. 1, for simplicity of illustration, only one information-processing device 10 is shown. Post server 20 is a server device that provides a service relating to one or a plurality of communities (for example, bulletin boards). In a community, posted information from each of a plurality of information-processing devices 10 is transmitted to post server 20. Post server 20 includes storage unit 21. Storage unit 21 stores posted information database 212 and community database 213. Posted information database 212 is a database for storing plural items of posted information. Community database 213 is a database for recording information relating to communities. Post server 20 provides any one of the information-processing devices 10 with posted information stored in posted information database 212 in response to a request for the posted information from one of the information-processing devices 10. Posted information includes text (character strings), handwritten messages (including at least one of a handwritten message and a handwritten image), and/or an image as a comment or a message input by a user. In other words, a user of information-processing device 10 can browse opinions, impressions, questions, comments and/or messages (hereinafter, referred to as “messages”) posted by other members, share (post) his/her messages, or exchange messages with other members of the community.

It is to be noted that the providing access to a community for sharing posted information is an example of a service for providing the posted information. Services for posting information other than that of the community may also be provided; for example, a blog, or a so-called buzz marketing site. Further, in this example, a single service may have plural communities, each of which corresponds to a different application program. Moreover, the different sorts of services for sharing posted information, each corresponding to a different application program, may be provided individually. For example, a community may be provided application program A, and a buzz marketing site may be provided application program B.

Information-processing device 10 includes input unit 11, handwritten character receiving unit 12, text receiving unit 13, input selecting unit 14, posting unit 15, obtaining unit 16, and display control unit 17. Input unit 11 inputs an image indicating a trajectory of handwriting (in other words, handwritten characters and/or handwritten images) made by a user to information-processing device 10. Handwritten character receiving unit 12 receives the trajectory (image) input via input unit 11 as posted information. Text receiving unit 13 receives input of text consisting of at least one character selected from a character set that includes predetermined plural characters (for example, Japanese syllabary characters and Chinese characters in Japanese, and letters of the alphabet in English) as posted information. Input selecting unit 14 selects one unit from handwritten character receiving unit 12 and text receiving unit 13. Posting unit 15 posts an item of posted information received by the unit selected by selecting unit 14 to a community. Obtaining unit 16 obtains at least one item of posted information posted by another user from post server 20. Display control unit 17 controls display unit 19 to display the posted information obtained by obtaining unit 16. Display unit 19 displays posted information in either the form of text, image (handwritten image), or both.

FIG. 2 shows an example of a hardware configuration of information-processing device 10. In this example, information-processing device 10 is a game device for playing a video game. Information-processing device 10 is a computer device including CPU (Central Processing Unit) 101, memory 102, external memory IF 103, input module 104, display controller 105, sound module 106, and communication module 107. Information-processing device 10 is connected to display device 50. Display device 50 is a device for displaying information such as an image and/or a character string, and includes a display (for example, liquid crystal display panel, organic electro-luminescence display panel, and so on) and a driver circuit thereof. In this example, information-processing device 10 is a so-called console type game device that does not include display device 50. Display device 50 is an external device, such as a television. It is to be noted that information-processing device 10 may include display device 50.

CPU 101 is a device for controlling elements of information-processing device 10, and executes various processes or calculations. Memory 102 is a storage device for storing a program and data, and has, for example, RAM (Random Access Memory) and/or ROM (Read Only Memory).

External memory IF 103 is an interface for reading/writing a program and/or data from/into an external storage medium (for example, an optical disk, a magnetic disk, or a semiconductor memory) that stores a program and/or data. Input module 104 is an input device for inputting an instruction or command from a user to CPU 101, and includes, for example, a keypad, buttons, a touch screen, a microphone, or a combination thereof. Display controller 105 is a device for controlling a display device to display information such as an image and/or a character string, and includes, for example, an image processing circuit and an image signal output circuit. Sound module 106 is a device for outputting a sound signal, and includes, for example, a sound processing device and a sound signal output device. Communication module 107 is a device for communicating with other devices following a predetermined communication standard via a wired and/or a wireless network (for example, the Internet).

In this example, input module 104 has an input device, for example, a display or a tablet with a touch screen, for inputting an image handwritten by a user.

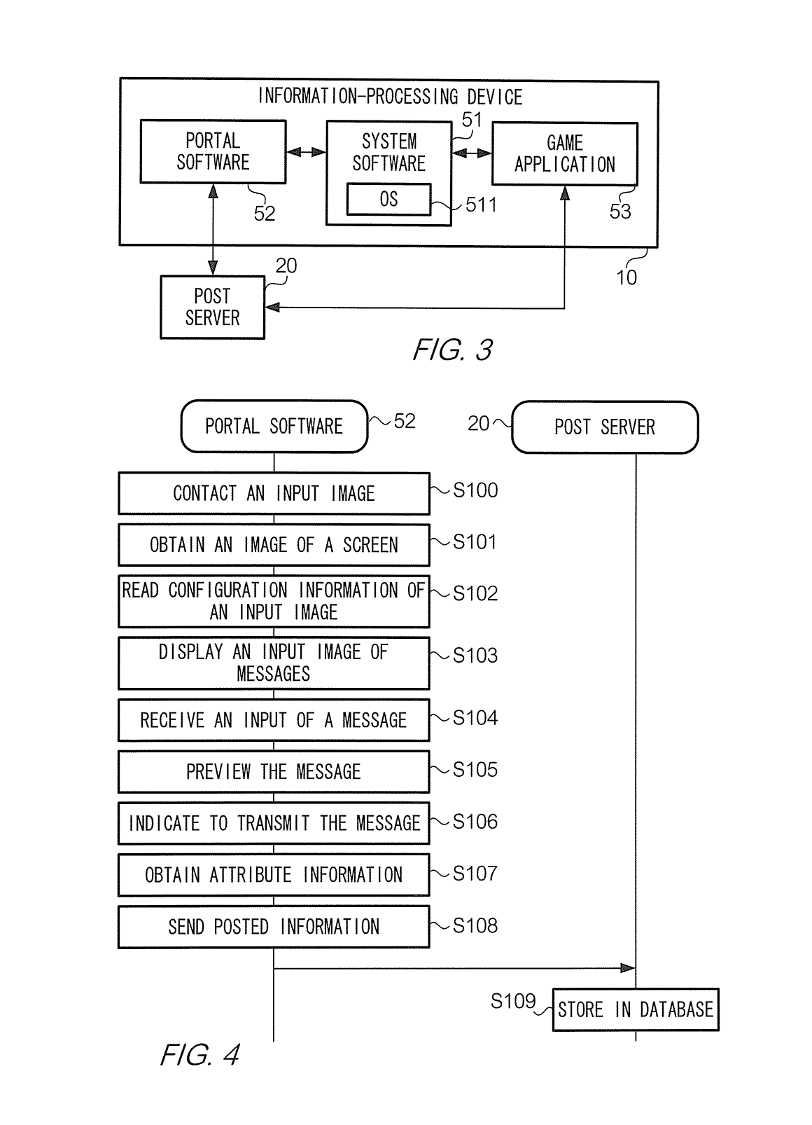

FIG. 3 shows an example of a software configuration of information-processing device 10. Information-processing device 10 includes system software 51, portal software 52, and game application 53.

System software 51 is software for managing and/or controlling information-processing device 10. System software 51 is software necessary to execute an application program on information-processing device 10, and it is executed in information-processing device 10 at any time when an application program is executed. In this example, system software 51 includes OS (Operating System) 511. OS 511 is essential software to manage and/or control portal software 52 and an application program such as game application 53.

Portal software 52 is client software for using a community providing service, and provides a user interface for showing information to a user and receiving input of information from a user. Portal software 52 transmits a request to post server 20, and controls the display device to display an image relating to the community, in accordance with data transmitted from post server 20 in response to the request. The image relating to the community includes an image of one or more sets of posted information posted by one or more user(s) and a UI (User Interface) for inputting and transmitting posted information.

It is to be noted that one active user is identified in a so-called login process when plural users share information-processing device 10.

Game application 53 is an application program (software) for realizing a video game on information-processing device 10. Information-processing device 10 has a function to execute at least one game application selected from various game programs. A program of game application 53 is stored, for example, in a storage medium (an external memory). A user instructs information-processing device 10 to read a program stored in a storage medium that is selected by the user from among plural storage media storing different programs. Thus, the user causes information-processing device 10 to execute the selected game application. In another example, memory 102 stores plural programs. A user may select a program to be started, and cause information-processing device 10 to execute the selected game application.

In this exemplary embodiment, system software 51 and portal software 52 are preinstalled in memory before information-processing device 10 is sold. In other words, system software 51 and portal software 52 are provided as functions of a platform of information-processing device 10. Game application 53 is stored in an external memory. It is to be noted that game application 53 may be stored in memory 102. In another example, at least one of system software 51, portal software 52, and game application 53 may be provided by being downloaded via a network and may be updated to the latest version via the network.

Input module 104 is an example of handwritten character input unit 11. CPU101 executing portal software 52 is an example of handwritten character receiving unit 12, text receiving unit 13, input selecting unit 14, posting unit 15, obtaining unit 16, and display control unit 17. Display device 50 is an example of display unit 19.

### 2. Operation

Operations of information-processing system 1 for providing a service community include posting and browsing messages. The operations of these examples will be described below. It is to be noted that, in the following descriptions, software such as portal software 52 is described as a subject that executes the process. These descriptions mean that CPU101 executes the process in cooperation with other hardware resources of information-processing device 10 following instructions of the software.

### 2-1. Transmitting Posted Information

FIG. 4 shows an example of a sequence chart illustrating a process for posting messages. Here, description is given for an example in which information-processing device 10 contacts portal software 52 when game application 53 is being executed, and posts a message via portal software 52. In step S100, portal software 52 contacts an image of a screen for inputting a message. The above contact is triggered by a predetermined event, for example, an event indicating that starting portal software 52 is instructed.

In step S101, portal software 52 obtains an image of a screen of the application program being executed. The application program “being executed” is an application program being executed at the time when starting portal software 52 is instructed, and, in this example, game application 53 is the application program being executed. While portal software 52 is activated, game application 53 is temporarily paused. While game application 53 is paused, data used for game application 53 is temporarily stored in memory 102. When the suspension is cancelled (when game application 53 becomes active), game application 53 restarts the game with the status of the timing when the suspension was made using data temporarily stored in memory 102. Portal software 52 generates a screen shot image based on the data of game application 53 temporarily stored in memory 102.

In step S102, portal software 52 reads configuration information on input screen from memory 102. The configuration information on input screen is information indicating whether an input screen for handwritten messages is used or an input screen of software keyboard is used. The configuration information on input screen is configured by the user, and is stored in memory 102. Alternatively, the configuration information on input screen may be automatically configured by system software 51, for example, by configuring an input screen that was used last as the input screen that is to be used the next time.

In step S103, portal software 52 instructs display device 50 to display an input screen designated by the configuration information on input screen read from memory 102. It is to be noted that portal software 52 may display a selection screen for prompting a user to select: one input screen for handwritten messages from a plurality of input screens displayed; and another, input screen of software keyboard, and let the user select one of the input screens to be used, instead of performing the operations in step S102 and step S103.

FIG. 5 shows an image of an input screen for input of handwritten messages. The image of the input screen includes drawing area 81, drawing setting buttons 82, input switching button 83, and posting button 84. In FIG. 5, pointing device P is also drawn in addition to the image. Pointing device P is, for example, a stylus pen. Drawing area 81 is an area in which the user draws an image in handwriting. For example, in a case where input module 104 includes a touch screen, when the touch screen is touched by pointing device P at a position in drawing area 81, a dot is drawn at the position. When pointing device P is moved while keeping contact with the touch screen, a trajectory of the moving contact point is drawn as an image in drawing area 81. Drawing setting buttons 82 are buttons for setting parameters for drawing such as, for example, width of line, color of line, and so on. Input switching button 83 is a button for switching the input screen for handwriting to the input screen of software keyboard. When input switching button 83 is touched, the input screen currently selected is switched to the input screen of software keyboard. Posting button 84 is a button for posting a message on inputting, and instructing information-processing device 10 to transmit the message to post server 20.

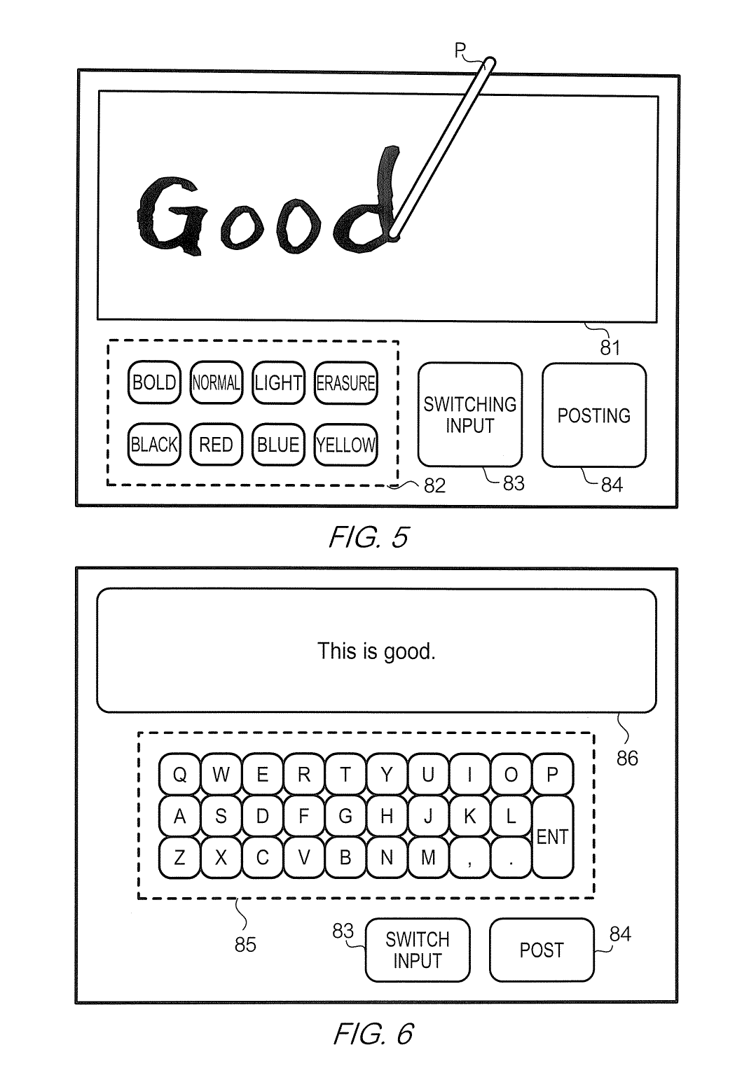

FIG. 6 shows an example of an image of an input screen of software keyboard. The image of the input screen of software keyboard includes input switching button 83, posting button 84, keyboard area 85, and window 86. Keyboard area 85 is an area for displaying a keyboard (a so-called software keyboard) of a predetermined character set. For example, when a position corresponding to a key “A” is touched, a character “A” is input. Window 86 is a window for displaying input characters.

Referring to FIG. 4 again, in step S104, portal software 52 receives a message input in the input screen selected by the user from among the input screens for handwritten messages and the input screen of software keyboard. Portal software 52 stores data that indicates the received message in memory 102. Data stored here is image data that indicates a trajectory of contact point moved in the input screen of handwritten messages, and text data that indicates a text input in the input screen of software keyboard. Identification information that indicates that the data is message data, is added to the image data and/or text data.

In step S105, portal software 52 previews the input message. More specifically, portal software 52 instructs display device 50 to display an image indicating the input message. The message is previewed at the time when the message is input (in real time). Alternatively, preview button may be provided in the input screen, and the message may be previewed by the preview button being touched.

A user instructs instructing information-processing device 10 to transmit the message (for example, by touching posting button 84) when the user completes (in step S106) an input of a message. In response to the instruction, information-processing device 10 identifies the input message as an item of posted information.

In step S107, portal software 52 obtains attribute information that is added to the item of posted information. In this example, a time stamp, a user name, an application ID, and a community ID are used as the attribute information. The time stamp indicates the present time. The application ID is identification information of application program that is suspended. The time stamp, the user name, and the application ID are held by OS 511. Portal software 52 obtains the timestamp, the user name, and the application ID from OS 511. The community ID is identification information of a community to which the item of posted information will be transmitted. The community ID is identification information of a community that portal software 52 accesses. Portal software generates the community ID from the application ID according to a predetermined rule.

In step S108, portal software 52 transmits the item of posted information to post server 20. The item of posted information includes data indicating the message identified in step S106, the screen shot obtained in step S101, and attribute information obtained in step S107.

In step S109, post server 20 stores the received item of posted information in posted information database 212.

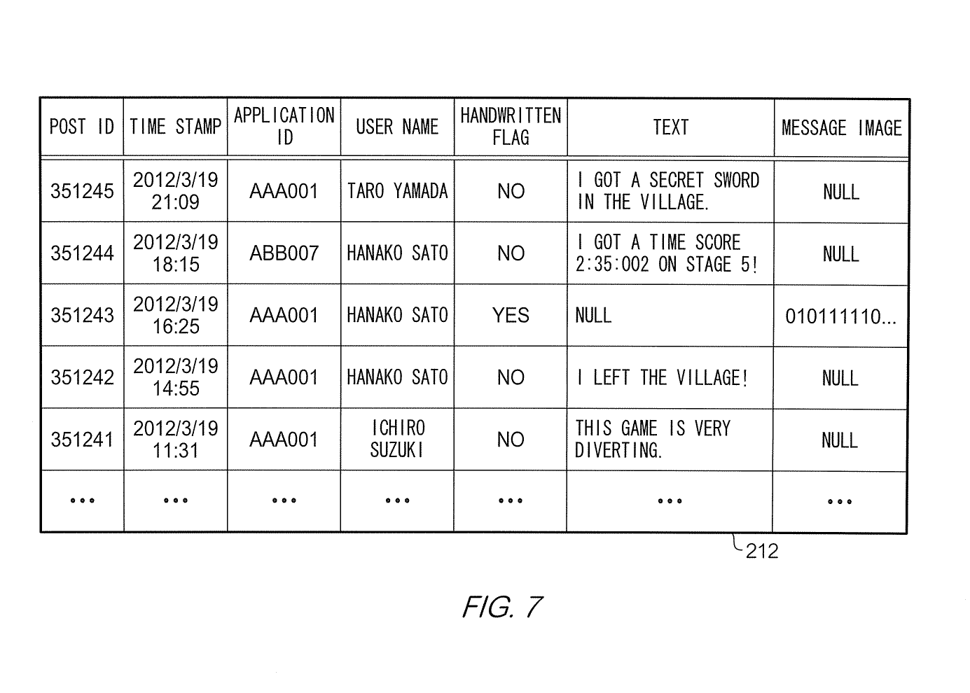

FIG. 7 shows an example of data stored in posted information database 212. Plural data sets are stored in posted information database 212. Each data set includes a post ID, a time stamp, an application ID, a user name, a handwritten flag, a text, and a message image. The post ID is identification information for identifying posted information. The post ID is a number automatically given by post server 20 according to a predetermined rule (for example, the post ID is sequentially determined on the basis of the order of reception of the posted information). The time stamp indicates the time when the posted information is received (or when the posted information is posted). The application ID is identification information for identifying an application program corresponding to the posted information, more specifically, an application program that is under execution in information-processing device 10 at the time when an instruction to post the subject posted information is made. The user name is identification information of a user who posts the subject posted information. The handwritten flag is a flag that indicates whether the message is handwritten (the message is in an image format) or not. In this example, when the value of the handwritten flag is “YES,” the flag indicates that the message is handwritten, and when the value of the flag is “NO,” the flag indicates that the message is a text. The text consists of character strings input by the user. The message image is an image that indicates the message input by the user (in the example shown in FIG. 7, bit string data indicating the image is shown just for descriptive purposes). In this example, the message is either a text or handwritten messages (image). Therefore, when the data set includes a text, the data set does not include a message image data, and when the data set includes a message image data, the data set does not include a text. It is to be noted that FIG. 7 merely shows an example, and information included in the posted information is not restricted to the example. For example, a part of information shown in FIG. 7 may be omitted, and/or other information may be added to the example.

Post server 20 stores the text in posted information database 212 when the received posted information includes a message that consists of a text. When post server 20 stores the text, post server 20 stores “NO” as a value of handwritten flag of the data set. On the other hand, post server 20 stores the message image in posted information database 212 when the received posted information includes a handwritten message. When post server 20 stores the image, post server 20 stores “YES” as a value of handwritten flag of the data set.

### 2-2. Browsing Posted Information

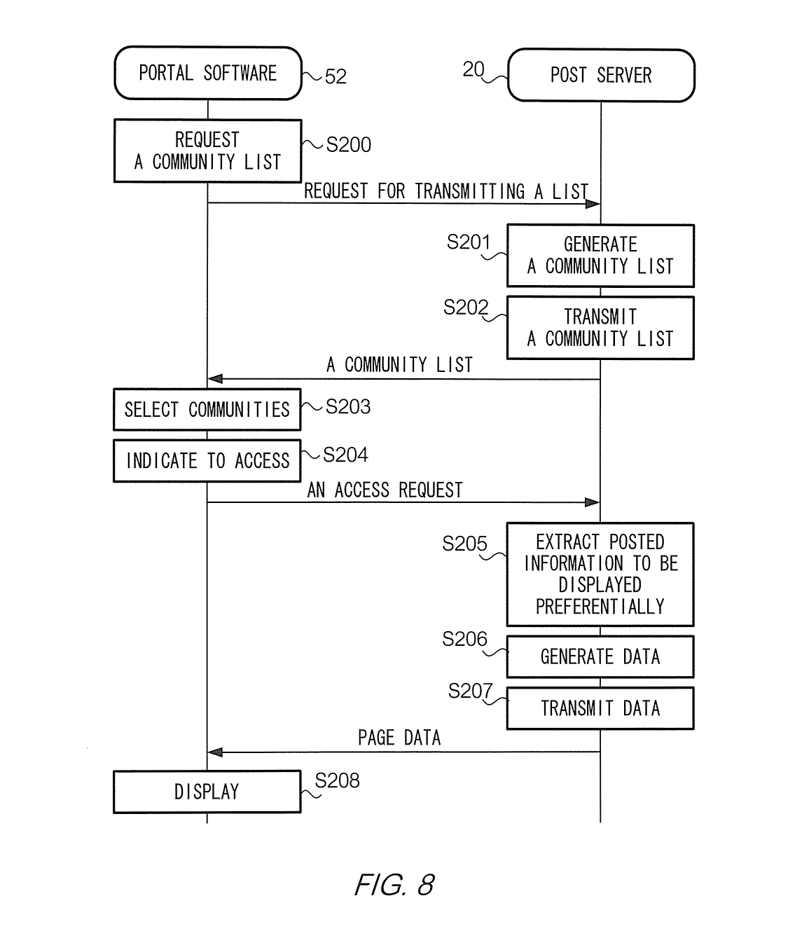

FIG. 8 shows an example of a sequence chart illustrating a process for browsing information posted to a community. Here, description is given for an example in which portal software 52 accesses a community and browses posted information.

In step S200, portal software 52 transmits a request for a list of communities to post server 20. The request includes the user name of a user of information-processing device 10. When post server 20 receives the request from information-processing device 10, post server 20 extracts (in step S201) from community database 213 information showing communities that satisfy a predetermined condition (for example, communities to which the user specified by the user name included in the request belongs, communities that are selected from among communities to which the user does not belong and pre-registered, communities that satisfy a search condition designated by the user, and so on), and generates a list of the extracted communities (hereinafter, referred to as “community list”). The community list includes community IDs for identifying communities. It is to be noted that all information registered in community database 213 may be extracted and the community list may include information on all of the communities registered in community database 213.

In step S202, posted server 20 transmits the generated community list to information-processing device 10 that is the originator of the request. When portal software 52 receives the community list, portal software 52 instructs display device 50 to display an image of a screen for prompting the user to select one of the communities in the list. The user selects, by way of the screen (in step S203) a community to be browsed. After a community is selected, portal software 52 transmits (in step S204) a request for accessing post server 20. The request includes the user name of a user of information-processing device 10, and community ID of the selected community.

When post server 20 receives the request from information-processing device 10, post server 20 extracts (in step S205) posted information that should be preferentially displayed from the posted information recorded in posted information database 212. The posted information that should be preferentially displayed may be determined, for example, on the basis of information on time (for example, a certain number of posted information data sets that were most recently received may be determined as the posted information data sets to be preferentially displayed); on the basis of information on a user (for example, a certain number of posted information data sets that were posted by other users whose status is friends of the user, may be determined as the posted information data sets to be preferentially displayed); and so on. It is to be noted that all posted information may be displayed without preference, instead of only a part of posted information being preferentially displayed. Post server 20 generates (in step S206) data describing the extracted posted information in a predetermined format (hereinafter, referred to as “page data”). Post server 20 transmits (in step S207) the generated page data to information-processing device 10 that is the originator of the request.

When portal software 52 receives the page data from post server 20, portal software 52 displays (in step S208) a screen with information on a community in accordance with the received page data.

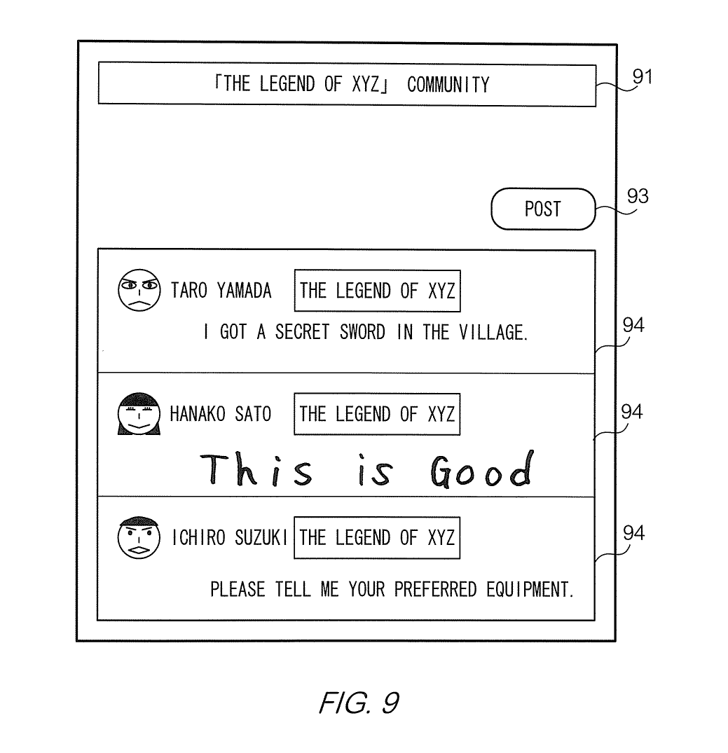

FIG. 9 shows an image of a screen with information on a community. The screen includes title 91, post button 93, and plural items of posted information 94. Title 91 shows a title of the community. Title 91 includes information (at least one of text and image) for identifying the application program to which the community corresponds. In this example, title 91 shows that the community relates to a game of “the Legend of XYZ.” Post button 93 is a button for instructing to display a screen for inputting a message. Posted information 94 shows contents of information posted by the user.

In this example, posted information 94 includes a user image, a user name, a game title, and a message. The user image shows an image registered for each user such as a so-called avatar image. The user name shows information for identifying the user (a name of the user, and so on). The game title shows the game title corresponding to posted information 94. The message shows a message (information, opinion, and so on) input by the user. In this example, the message may contain either a text message or a handwritten message. In the example shown in FIG. 9, for example, the second posted information 94 is a handwritten message.

### 2-3. Conclusion

According to information-processing system 1, a user who is not used to using a keyboard can input a message more easily than using a keyboard. On the other hand, a user who is used to using a keyboard can input a message by using a keyboard. A user can post and browse posted information by a common interface either when the user inputs a message in handwriting or by use of a keyboard. Further, according to information-processing system 1, a user can post a message not only in a format using a predetermined character set, but also in a format of a handwritten image. Therefore, according to information-processing system 1, the user can post his/her messages in various ways.

### 3. Modification

The technology is not restricted to the embodiments described above. Various modifications can be applied to the exemplary embodiment. Some modifications will be described below. Two or more modifications from among the following modifications may be combined.

In the above embodiment, description is given for an example in which one of a text or a handwritten drawing (image) is included as a message in a single set of posted information. However, both a text and a handwritten drawing (image) may be included as messages in a single set of posted information.

In the above embodiment, description is given for an example in which an image of a screen is added to posted information. Data generated by game application 53 (or data being used by game application 53) may be added to posted information, as substitute for an image of a screen (or in addition to an image of a screen). The data may be binary data showing, for example, a virtual object such as an item or a character, a map, a field, or a score used in the game, and so on).

A data format of handwritten message data is not restricted to the example of the above embodiment. In the above embodiment, handwritten message data is transmitted as image data. However, handwritten message data may be a plurality of sets of coordinates indicating a trajectory. In such a case, portal software 52 may display the handwritten messages by replaying a process of drawing the trajectory according to the coordinates.

In the above embodiment, portal software 52 receives both a handwritten message and a text message. However, portal software 52 may receive only a handwritten message.

The software configuration of information-processing device 10 is not restricted to the example described in the embodiment. For example, game application 53 may include a function of a client of a service that is provided to a community. In such a case, posting and browsing a message may be executed in accordance with game application 53, not portal software 52. Information-processing device 10 is not restricted to a console type game device.

Information-processing device 10 may be any type of a game device other than a console type game device such as a portable game device, a personal computer, a mobile phone, a PDA (Personal Digital Assistants), or a tablet device. Further, an application program executed in information-processing device 10 is not restricted to a game application. The application program may be other than the game application, for example, a word processing application, educational application, or any other utility software.

The hardware configuration of information-processing device 10 is not restricted to the example shown in FIG. 2. Information-processing device 10 may have any hardware configuration as long as the functions shown in FIG. 1 can be implemented by information-processing device 10. Sequence charts described in the above embodiment are merely examples. The order of the processes is not restricted to the examples.

Combination of devices constructing information-processing system 1 and assigning of functions among the devices are not restricted to those described in the above embodiment. For example, at least some of the functions described as functions of information-processing device 10 may be assigned to a server device. In such a case, some of the functional units of the information-processing system may be realized by processes executed by a processor of the information-processing device, processes executed by a processor of the server device, or processes executed by both of the processors of the information-processing device and the server device. The processes may be assigned to the information-processing device and the server device in any way according to common knowledge of those skilled in the art. Further, the server device may be either the same device as that of post server 20, or a different device.

The application program executed in information-processing device 10 is not restricted to an application program that is provided in a storage medium. The application program may be provided by downloading via a network such as the Internet. Further, the system software of information-processing device 10 may be provided by a storage medium or by downloading.

What is claimed is:

1. An information-processing device comprising:
a first receiving unit configured to receive handwritten data input via an input device as posted information, the handwritten data showing an handwritten image; and
a posting unit configured to post the posted information received by the first receiving unit to a service that is provided to one or more communities.

2. The information-processing device according to claim 1, wherein
the service is provided to a plurality of communities.

3. The information-processing device according to claim 2, further comprising:
a community selecting unit configured to select one or more communities from among the plurality of communities, and wherein
the posting unit is further configured to post the posted information to the one or more communities selected by the community selecting unit.

4. The information-processing device according to claim 1, further comprising:
a second receiving unit configured to receive an input of text as the posted information, the text consisting of one or more characters selected from among a character set including a plurality of predetermined characters, and wherein
the posting unit is further configured to post the posted information received by the second receiving unit to the service.

5. The information-processing device according to claim 4, further comprising:
a receiving unit selecting unit that selects one of the first receiving unit and the second receiving unit, and wherein
the posting unit is further configured to post the posted information received by the receiving unit to the service, the receiving unit being selected by the receiving unit selecting unit.

6. The information-processing device according to claim 4, further comprising:
an obtaining unit that obtains a plurality of sets of posted information from the service, the plurality of sets of posted information being posted from another computer and each of the plurality of sets of posted information containing the handwritten data and/or the text; and
a display control unit that controls a display to display the plurality of sets of posted information obtained by the obtaining unit.

7. The information-processing device according to claim 1, wherein
the posting unit is further configured to attach attached data to the posted information and post the posted information to the service, the attached data being that corresponding to the posted information.

8. A computer-readable non-transitory storage medium storing a program causing a computer device including an input device to execute a process, the process comprising:
receiving handwritten data input via the input device as posted information, the handwritten data showing an handwritten image; and
posting the received posted information to a service that is provided to one or more communities.

9. An information-processing method performed in a computer device including an input device comprising:
receiving handwritten data input via the input device as posted information, the handwritten data showing an handwritten image; and
posting the received posted information to a service that is provided to one or more communities.

10. An information-processing system comprising:
a server that provides a service for providing posted information; and
an information-processing device including an input device, wherein the information-processing device includes:
a first receiving unit that receives handwritten data input via an input device as posted information, the handwritten data showing an handwritten image; and
a posting unit that posts the posted information received by the first receiving unit to the service that is provided to the one or more communities.
